(19) United States
(12) Patent Application Publication
(10) Pub. No.: US 2017/0314324 A1
(43) Pub. Date: Nov. 2, 2017

(54) ACTUATION DEVICE FOR THE SLATS OF A SHUTTER

(71) Applicant: I.QUATTRO S.R.L., San Marcello (AN) (IT)

(72) Inventor: Alessandro CIRILLI, Jesi (AN) (IT)

(73) Assignee: I.QUATTRO S.R.L., San Marcello (AN) (IT)

(21) Appl. No.: 15/491,224

(22) Filed: Apr. 19, 2017

(30) Foreign Application Priority Data
Apr. 29, 2016 (IT) 102016000043750

(51) Int. Cl. E06B 9/28; E06B 9/384; E06B 9/386

(52) U.S. Cl. CPC E06B 9/28; E06B 9/386; E06B 9/384; E06B 2009/285

(57) ABSTRACT

An actuation device for the slats of a wing of a shutter has two sections intended to be mounted in the uprights of a frame of the wing, a plurality of flanges that are rotatably mounted in holes obtained in the sections, and locking devices disposed in such a way to hold the flanges and prevent the flanges from coming out of the holes of the section.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present patent application for industrial invention relates to an actuation device for the slats of a shutter.

### 2. Description of Related Art Including Information Disclosed Under 37 CFR 1.97 and 37 CFR 1.98

Shutters are known, which comprise wings having a frame and slats that are rotatably mounted with respect to the frame along a horizontal axis. Said slats rotate simultaneously in order to vary the amount of light passing through the window.

In particular, when all slats are in a horizontal position, large gaps are generated between the slats in such a way that the light passes through said gaps. Instead, when all slats are disposed in vertical direction, no gaps are provided between the slats and the light is therefore screened by the slats.

Said slats are actuated by means of an actuation device, which is connected to uprights of the frame of the wing.

The actuation device comprises two sections that are mounted in the uprights of the frame. Each section has a plurality of holes that corresponds in number to the number of the slats.

The actuation device comprises a plurality of flanges that are rotatably mounted in the holes of the sections.

The actuation device comprises a pair of bars that are connected to the flanges of each section in order to synchronize the rotation of the flanges.

Each slat comprises a plug. The plug is intended to be inserted into a housing of the flange in order to connect the slat to the flange.

Such a known type of shutter is impaired by a drawback during the mounting operation. In fact, several separate elements are necessary to mount the shutter, namely: the uprights of the frame of the wing, the sections, the flanges, the bars of the synchronization devices and the slats of the wing. The operator must insert a flange in the hole of the section and simultaneously insert the plug of the slat into the flange. It appears evident that such an operation is complicated, wearisome and time-consuming, because the operator must mount the flanges and the slats one by one. On the other hand, the flanges cannot be pre-mounted in the section; otherwise they would fall off the section because the flanges are not held by any holding devices.

Such a drawback implies that it is not possible to produce the frame of the wing of the shutter first, with the actuation device already mounted in the frame of the wing and, successively, fasten the slats of the wing to the actuation device.

DE10103032 discloses a shutter with adjustable horizontal slats and a synchronization element for a synchronous movement of the slats.

US2003136053 discloses a shutter comprising a rectangular frame and a plurality of shutter blades rotatably mounted on the frame, in such a way to be in a closed position and in an open position. Control bodies are connected to the frame and to the blades in order to move the blades.

EP0205410 discloses a louvre system with adjustable slats, comprising removable modular slat clips.

US2005120628 discloses an electrical louvered shutter comprising one wing and a plurality of louver slats that are movably pivotally connected to the wing.

CN2402786 discloses an adjustable glass window.

### BRIEF SUMMARY OF THE INVENTION

The purpose of the present invention is to remedy the drawbacks of the prior art, by providing an actuation device that can be mounted on the frame of the wing of a shutter independently from the mounting of the slats of the wing on the actuation device.

An additional purpose of the present invention is to disclose an assembly provided with said actuation device.

The actuation device according to the present invention is intended to actuate the slats of a wing of a shutter and comprises two sections mounted in the uprights of a frame of the wing. Each section has a longitudinal axis and a plurality of holes that correspond in number to the number of slats and are obtained along the longitudinal axis of the section.

The actuation device comprises a plurality of flanges that are rotatably mounted in the holes of the sections. Each flange comprises fastening devices intended to be fastened with the fastening devices of the slat.

The actuation device comprises synchronization devices connected to the flanges of each section in order to synchronize the rotation of the flanges and locking devices disposed in such a way to hold the flanges and prevent them from coming out of the holes of the section.

The peculiarity of the actuation device according to the present invention consists in the fact that said locking devices comprise at least one parallel pair of ribs that protrude from the section and define a housing that receives the flanges.

The advantages of the actuation device according to the present invention are evident, wherein the flanges can be held in position by means of the locking devices of the section, and is consequently possible to mount the actuation device on the frame of the wing of the shutter, independently from the mounting of the slats in the actuation device.

In fact, the flanges are held in position in the section by the locking devices of the section.

### BRIEF DESCRIPTION OF THE SEVERAL VIEWS OF THE DRAWINGS

For the sake of clarity, the description of the actuation device according to the present invention continues with reference to the attached drawings, which have a merely illustrative, not limiting value, wherein:

FIG. 1 is an axonometric view of a shutter assembly according to the present invention, which partially shows an actuation device according to the present invention and a slat, with separate views;

FIG. 2 is an axonometric view of the actuation device of FIG. 1 rotated by 180°;

FIG. 3 is an exploded axonometric view of the shutter assembly of FIG. 1.

### DETAILED DESCRIPTION OF THE INVENTION

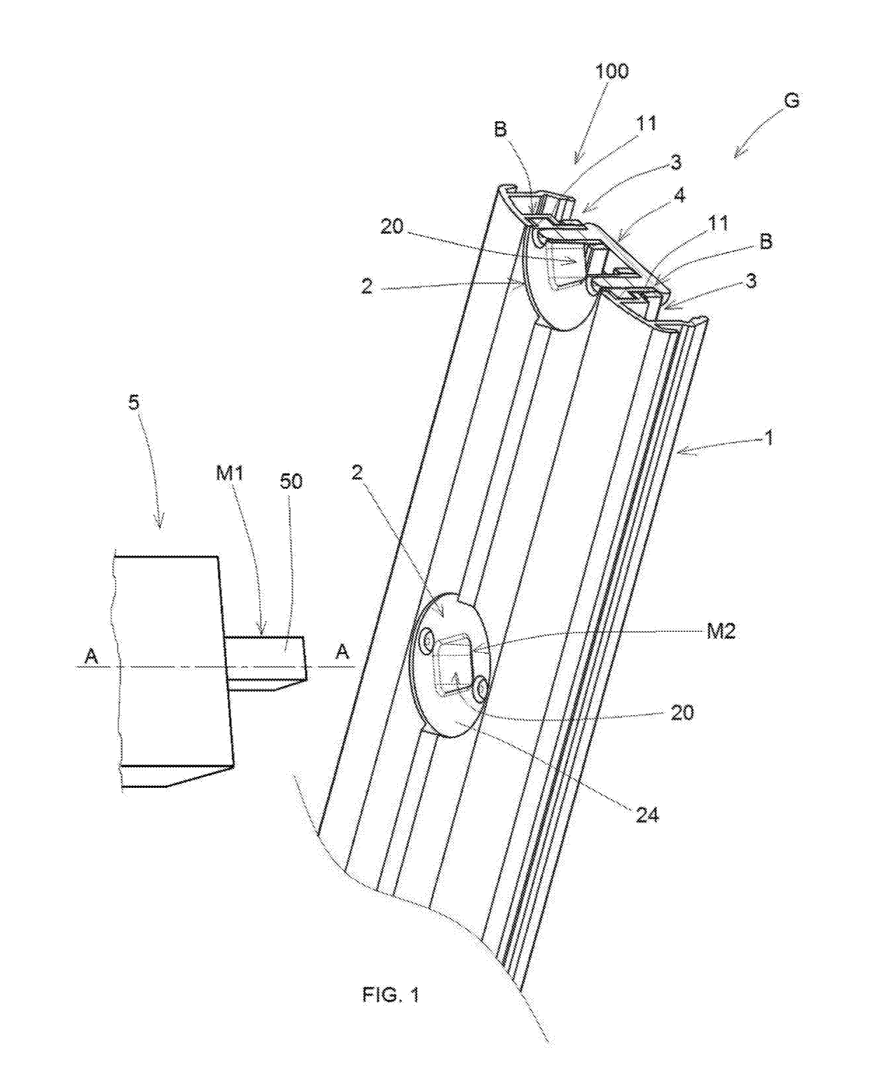

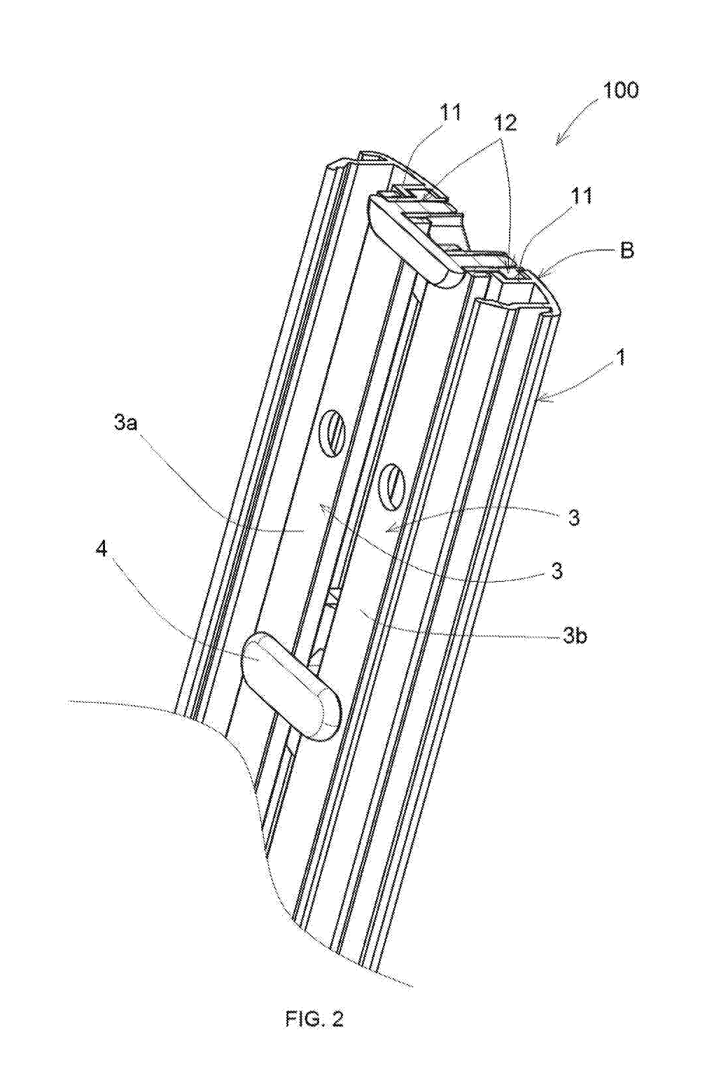

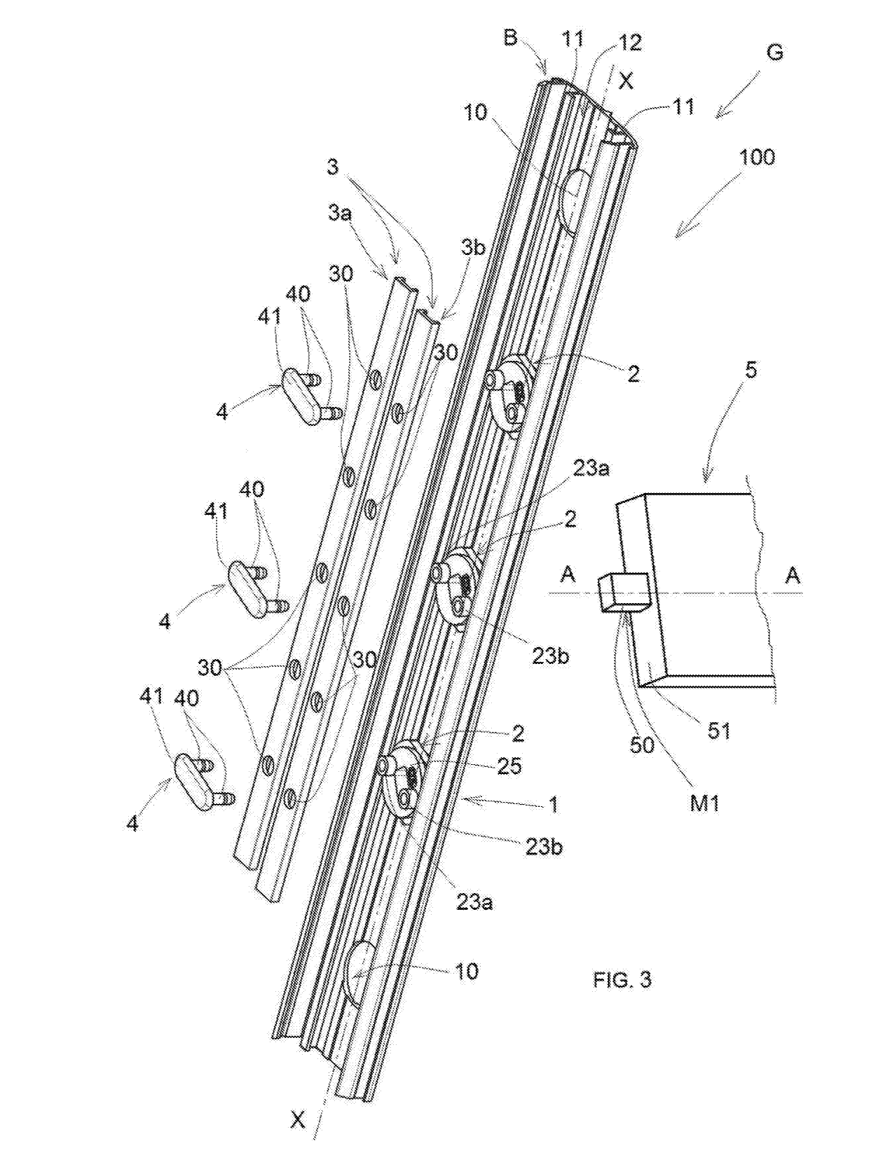

With reference to FIGS. 1 to 3, a shutter assembly according to the present invention is disclosed, which is generally indicated with reference numeral (G).

The shutter assembly (G) comprises at least one wing, comprising a frame formed of two uprights and two crosspieces.

The wing comprises a plurality of slats (5) movably and adjustably mounted with respect to the frame of the wing.

In particular, the slats (5) rotate in a synchronous way. In view of the above, it is possible to increase or decrease the quantity of light passing through the shutter.

Each slat (5) is shaped as a rectangular plate that extends along a longitudinal axis (A). The slats (5) have two end walls (51) that are disposed in transverse direction with respect to the longitudinal axis (A) of the slat. Fastening devices (M1) are provided in the end walls (51) of the slat.

The fastening devices (M1) may comprise a plug (50) that protrudes from each end wall (51) along the longitudinal axis (A) of the slat. Advantageously, the plug (50) is mounted in a housing of the slat (5) and is pushed outwards by a spring. In this way, when the plug (50) is pressed, the plug (50) returns inside its housing against the action of the spring. When the plug (50) is released, the spring pushes the plug (50) out of its housing. Alternatively, the fastening devices (M1) may comprise a recessed housing in the end wall (51) of the slat.

The shutter assembly (G) comprises an actuation device (100) intended to actuate the slats (5). The actuation device (100) comprises two sections (1) intended to be vertically mounted in the uprights of the frame of the wing.

Each section (1) has a longitudinal axis (X) and is provided with a plurality of circular holes (10) that correspond in number to the number of slats (5) and are obtained along the longitudinal axis (X) of the section (1).

The actuation device (100) comprises a plurality of flanges (2) rotatably mounted in the holes (10) of the sections (1). Each flange (2) comprises fastening devices (M2) intended to be fastened with the fastening devices (M1) of the slat.

Advantageously, the fastening devices (M2) of the flange may comprise a housing (20) disposed in a central position of the flange (2). Each housing (20) of the flanges (2) is intended to house the plug (50) of the slat (5).

The housing (20) consists in a non-circular hole. In particular, the housing of the flange (2) has a rectangular shape. The plug (50) of the slat (5) has a non-circular cross-section in such a way to prevent the plug (50) from sliding inside the housing (20) of the flange (2). In particular, the plug (50) of the slat (5) has a parallelepiped shape in such a way to be prismatically coupled with the rectangular housing (20) of the flange (2).

Alternatively, the fastening devices (M2) of the flange may comprise an eventually spring-loaded plug that is engaged inside a housing of the slat (5).

Each flange (2) comprises an internal wall (25) intended to face the frame and an external wall (24) intended to face the slat (5).

Each flange (2) comprises a first sleeve (23a) and a second sleeve (23b) that protrude from the internal wall (25) of the flange (2). The sleeves (23a, 23b) are eccentrically mounted and disposed in diametrally opposite position with respect to the center of the flange (2).

Each section (1) comprises locking devices (B) disposed in such a way to hold the flanges (2) and prevent the flanges (2) from coming out of the holes (10) of the section (1).

The locking devices (B) comprise a parallel pair of ribs (11) that protrude from the section (1). The ribs (11) of the section are parallel to the longitudinal axis (X) of the section (1) and define a housing (12) that receives the flanges (2).

The ribs (11) of the section have an “L”-shape in cross-section and are disposed in opposite position in such a way that the housing (12) has a “C”-shape.

Although not shown in the attached figures, the ribs may be perpendicular to the longitudinal axis (X) of the section (1). In such a case, the section comprises a pair of ribs for each flange.

The actuation device (100) comprises synchronization devices (3) connected to the flanges (2) of each section (1) in order to synchronize the rotation of the flanges (2).

The synchronization devices (3) comprise a first bar (3a) and a second bar (3b) in parallel position. The bars (3a, 3b) comprise a plurality of holes (30). The sleeves (23a, 23b) of the flanges (2) are rotatably mounted inside the holes (30) of the bars of the synchronization devices.

In particular, the first sleeves (23a) of each flange (2) are inserted into the holes (30) of the first bar (3a) and the second sleeves (23b) of each flange (2) are inserted into the holes (30) of the second bar (3b), in such a way that, by rotating a flange (2), the bars (3a, 3b) are actuated with a roto-translation movement, getting mutually closer or farther apart.

The rotation of the flanges (2) in one direction and in the opposite direction is limited by two stop points that are obtained when the bars (3a, 3b) come in mutual contact.

The actuation device (100) also comprises connection devices (4) connected to the synchronization devices (3) and to the flanges (2) in order to movably connect the synchronization devices (3) to the flanges (2).

The connection devices (4) comprise a body (41) from which two pins (40) protrude. The pins (40) of the connection devices are inserted into the sleeves (23a, 23b) of the flanges. As a consequence, the bars (3a, 3b) are disposed between the flange (2) and the connection devices (4) in such a way to prevent the bars (3a, 3b) from separating from the flange (2).

In order to rotate the slats (5) of the shutter, it is necessary to rotate a flange (2), in such a way to move the bars (3a, 3b). The bars (3a, 3b) make a roto-translation, thus moving also the other flanges (2).

Although not shown in the attached figures, each flange may comprise only one sleeve that is eccentrically mounted on the flange.

In such a case, the synchronization devices comprise only one bar, comprising holes that receive the sleeves of the flanges. The rototranslation of the bar is stopped in two stop points by stop devices, such as for example stoppers that are obtained or disposed on the section in order to stop the rotation of the flanges. The connection devices comprise only one pin that is inserted into the sleeve of the flange.

1. Actuation device for the slats of a wing of a shutter; said actuation device comprising:
two sections intended to be mounted in the uprights of a frame of the wing, each section having a longitudinal axis (X) and a plurality of holes that correspond in number with the number of the slats and are obtained along the longitudinal axis (X);
a plurality of flanges rotatably mounted in said holes of said sections; each flange being provided with fastening devices intended to be fastened with fastening devices (M1) of the slats;
synchronization devices connected to the flanges of each section to synchronize the rotation of the flanges;
wherein
said section comprises locking devices disposed in such a way to hold the flanges and prevent the flanges from coming out of the holes of the section, and
said locking devices comprise at least one parallel pair of ribs that protrude from said section, said ribs defining a housing that receives said flanges.

2. The actuation device according to claim 1, wherein said parallel pair of ribs of the section is parallel to the longitudinal axis (X) of the section.

3. The actuation device according to claim 1, wherein said ribs of the section have an “L”-shape in cross-section and are disposed in opposite position in such a way to form a “C”-shaped housing.

4. The actuation device according to claim 1, also comprising connection devices connected to the synchronization devices and to the flanges to movably connect the synchronization devices to the flanges.

5. The actuation device according to claim 4, wherein each flange comprises at least one sleeve that is eccentrically mounted; said connection devices comprising at least one pin inserted in said at least one sleeve.

6. The actuation device according to claim 1, wherein said synchronization devices comprise at least one bar connected to said flanges.

7. The actuation device according to claim 6, wherein said sleeves of the flanges are rotatably mounted in holes of the bar of the synchronization devices.

8. The actuation device according to claim 1, wherein said fastening devices of the flange comprise a housing disposed in a central position of the flange and comprising a non-circular hole intended to house, without possibility of sliding, a plug of the fastening devices of the slat.

9. The actuation device according to claim 1, wherein said synchronization devices comprise a first bar and a second bar in parallel position; each flange comprising a first sleeve and a second sleeve disposed in diametrally opposite positions with respect to the center of the flange; said first sleeves of each flange being inserted into the holes of the first bar and said second sleeves of each flange being inserted in the holes of the second bar in such a way that, by rotating a flange, said bars make a roto-translation, moving mutually closer or farther apart.

10. Shutter assembly comprising:
at least one wing comprising a frame composed of two uprights and two crosspieces, and a plurality of slats movably and adjustably mounted with respect to said frame; said slats being provided with fastening devices disposed at the two ends of the slats;
an actuation device according to claim 1.

11. The shutter assembly according to claim 10, wherein:
said fastening devices of the flange comprise a housing disposed in a central position of the flange and comprising a noncircular hole, and
said fastening devices of the slat comprise a plug that is engaged inside said housing of the flange; said plug having a non-circular cross-section, in such a way to prevent the plug from sliding inside the housing of the flange.

12. The shutter assembly according to claim 11, wherein said housing of the flange has a rectangular shape and said plug of the slat has a parallelepiped shape in such a way to be prismatically coupled with the housing of the flange.
